(19) United States
(12) Patent Application Publication
(10) Pub. No.: US 2009/0305598 A1
(43) Pub. Date: Dec. 10, 2009

(54) Manufacturing Method of Display Unit and Manufacturing Apparatus of Display Unit

(76) Inventors: Atsuo Nozaki, Tokyo (JP); Toshiyuki Ikariya, Tokyo (JP); Shigeyoshi Otsuki, Kanagawa (JP); Toshimasa Eguchi, Kanagawa (JP); Katsuji Takahashi, Chiba (JP); Shigenori Yamaoka, Kanagawa (JP)

Correspondence Address: FLYNN THIEL BOUTELL & TANIS, P.C., 2026 RAMBLING ROAD, KALAMAZOO, MI, 49008-1631, US

(21) Appl. No.: 11/990,732

(22) PCT Filed: Dec. 9, 2005
(86) PCT No.: PCT/JP2005/022629

§ 371 Date: Jun. 15, 2009

(30) Foreign Application Priority Data
Aug. 18, 2005 (JP) 2005-237584

(51) Int. Cl. H01J 9/20

(52) U.S. Cl. 445/25

(57) ABSTRACT

[Problem to be Solved] To continuously manufacture display units, and prevent warping or peeling of display units after sticking together, and eliminate mixture of air babbles, and prevent the occurrence of uneven images.

[Solution] A manufacturing apparatus of a display unit is provided in which upper and lower substrates are stuck together to manufacture a display unit, and that is equipped with at least a sealing agent application unit for applying a sealing agent onto the substrates, a liquid display material application unit for applying a liquid display material onto the substrates, and a substrate sticking unit for sticking upper and lower substrates, wherein the thickness of the upper and lower substrates is 10 μm to 500 μm and the elastic modulus thereof is 10 MPa to 100 GPa, and when the substrate having the plural pixels is the upper substrate, and the substrate having the driving unit is the lower substrate, and the linear expansion coefficients thereof are defines as A and B respectively, it stands that 1.0≦A/B<1.5, and when the elastic modulus of the sealing agent is defined as C, it stands that 1.0 GPa<C<10.0 GPa. Further, when the ratio of the space formed by the pore space between the sealing agent drawn on one of the substrates and the liquid display material is an area ratio D, it stands that 0.9≦D<1.0, when the ratio of the height of the liquid material to the height of the sealing agent is defined as F, it stands that 0.1≦E≦0.5, and in the substrate sticking unit for sticking continuous upper and lower substrates, the inclination angle of one of the substrate to the other substrate is set 5 degrees or above, and the substrates are pressurized at 1 N/cm² or above and stuck together at normal pressures.

### FIELD OF THE INVENTION

The present invention relates to a manufacturing method of a display unit and a manufacturing apparatus of a display unit for manufacturing a display unit in which upper and lower substrates are made of plastic and in a roll shape, and at least one substrate thereof has plural pixels, and at least the other substrate thereof has a driving circuit, and the upper and lower substrates are stuck together.

### DESCRIPTION OF THE RELATED ART

For example, as manufacturing methods of a liquid crystal display panel, there are methods in which liquid crystal display panels are manufactured continuously (for example, refer to Patent Document 1, Patent Document 2) by use of long-length flexible plastic films. Further, there is a method in which a sealing member having an opening portion is arranged in a sheet substrate, and liquid crystal is supplied to the opening portion of the sealing member, and a roll substrate and the sheet substrate are stuck together via the sealing member and the liquid crystal, and then the substrates are cut (for example, refer to Patent Document 3). Furthermore, there is a method for sticking substrates together involving a mechanism to warp one end portion of each substrate, in which substrates in their warped state are inserted into two pressing rollers and stuck together, and thereby liquid crystal is encapsulated between substrates entirely and without mixing of air bubbles (for example, refer to Patent Document 4).

Patent Document 1: Japanese Patent Application Laid-Open No. 54-126559

Patent Document 2: Japanese Patent Application Publication No. 61-61083

Patent Document 3: Japanese Patent No. 3206116

Patent Document 4: Japanese Patent Application Laid-Open No. 2004-170777

### DISCLOSURE OF THE INVENTION

### Problems to be Solved by the Invention

In the case when liquid crystal display panels are manufactured continuously as above, it is possible to improve the transfer speed of substrates, and when liquid crystal is applied, its application can be made easily since there is no need for heating up substrates. However, there is a fear that substrates may be deformed due to loads such as stretching and bending and the like working onto the substrates at the moment of their transfer, which becomes a cause of warping or peeling of liquid crystal panels after sticking substrates together.

Further, In the case when a sealing agent having an opening portion is formed, and a specified amount of liquid crystal is supplied, and substrates are stuck together in the atmosphere, liquid crystal leaks out from the opening portion in some cases. When substrates are stuck together after removing liquid crystal, air bubbles get into liquid crystal display panels, which becomes a cause of the occurrence of uneven images.

The present invention has been made in consideration of the above problems in the prior art, and accordingly, the object of the invention is to provide a manufacturing method of a display unit and a manufacturing apparatus of a display unit that can continuously manufacture display units, and prevent warping or peeling of display units after sticking together, and eliminate mixture of air babbles, and prevent the occurrence of uneven images.

### Means for Solving the Problems

In order to solve the above problems with the prior art, the present invention is structured as described below.

According to claim 1 of the invention, there is provided a manufacturing method of a display unit in which upper and lower substrates are made of plastic and in a roll shape, and at least one substrate thereof has plural pixels, and at least the other substrate thereof has a driving circuit, and the upper and lower substrates are stuck together, the manufacturing method comprising at least a sealing agent application step of applying a sealing agent onto the substrates,

a liquid display material application step of applying a liquid display material onto the substrates, and

a substrate sticking step of sticking upper and lower substrates, wherein

the thickness of the upper and lower substrates is 10 μm to 500 μm and the elastic modulus thereof is 10 MPa to 100 GPa, and

when the substrate having the plural pixels is the upper substrate, and the substrate having the driving unit is the lower substrate, and the linear expansion coefficients thereof are defines as A and B respectively, it stands that 1.0≦A/B<1.5, and when the elastic modulus of the sealing agent is defined as C, it stands that 1.0 GPa<C<10.0 GPa.

According to claim 2 of the invention, there is provided a manufacturing method of a display unit according to claim 1, further comprising a photo alignment film application step of performing an alignment process of applying a photo alignment film, before the sealing agent application step.

According to claim 3 of the invention, there is provided a manufacturing method of a display unit in which upper and lower substrates are made of plastic and in a roll shape, and at least one substrate thereof has plural pixels, and at least the other substrate thereof has a driving circuit, and the upper and lower substrates are stuck together, wherein when the ratio of the space formed by the pore space between the sealing agent drawn on one of the substrates and the liquid display material is an area ratio D, it stands that 0.9≦D<1.0,

when the ratio of the height of the liquid material to the height of the sealing agent is defined as F, it stands that 0.1≦E≦0.5, and

in the substrate sticking step of sticking continuous upper and lower substrates, the inclination angle of one of the substrate to the other substrate is set 5 degrees or above, and the substrates are pressurized at 1 N/cm² or above and stuck together at normal pressures.

According to claim 4 of the invention, there is provided a manufacturing method of a display unit according to claim 1 or 2, wherein

when the ratio of the space formed by the pore space between the sealing agent drawn on one of the substrates and the liquid display material is an area ratio D, it stands that 0.9≦D<1.0,

when the ratio of the height of the liquid material to the height of the sealing agent is defined as F, it stands that 0.1≦E≦0.5, and

in the substrate sticking step of sticking continuous upper and lower substrates, the inclination angle of one of the substrate to the other substrate is set 5 degrees or above, and the substrates are pressurized at 1 N/cm² or above and stuck together at normal pressures.

According to claim 5 of the invention, there is provided a manufacturing apparatus of a display unit in which upper and lower substrates are made of plastic and in a roll shape, and at least one substrate thereof has plural pixels, and at least the other substrate thereof has a driving circuit, and the upper and lower substrates are stuck together, the manufacturing apparatus comprising at least

a sealing agent application unit for applying a sealing agent onto the substrates,

a liquid display material application unit for applying a liquid display material onto the substrates, and

a substrate sticking unit for sticking upper and lower substrates, wherein

the thickness of the upper and lower substrates is 10 μm to 500 μm and the elastic modulus thereof is 10 MPa to 100 GPa, and

when the substrate having the plural pixels is the upper substrate, and the substrate having the driving unit is the lower substrate, and the linear expansion coefficients thereof are defines as A and B respectively, it stands that 1.0≦A/B<1.5, and

when the elastic modulus of the sealing agent is defined as C, it stands that 1.0 GPa<C<10.0 GPa.

According to claim 6 of the invention, there is provided a manufacturing apparatus of a display unit according to claim 5, further comprising a photo alignment film application unit for performing an alignment process of applying a photo alignment film, before the sealing agent application unit.

According to claim 7 of the invention, there is provided a manufacturing apparatus of a display unit in which upper and lower substrates are made of plastic and in a roll shape, and at least one substrate thereof has plural pixels, and at least the other substrate thereof has a driving circuit, and the upper and lower substrates are stuck together, wherein

when the ratio of the space formed by the pore space between the sealing agent drawn on one of the substrates and the liquid display material is an area ratio D, it stands that 0.9≦D<1.0,

when the ratio of the height of the liquid material to the height of the sealing agent is defined as F, it stands that 0.1≦E≦0.5, and

in the substrate sticking unit for sticking continuous upper and lower substrates, the inclination angle of one of the substrate to the other substrate is set 5 degrees or above, and the substrates are pressurized at 1 N/cm² or above and stuck together at normal pressures.

According to claim 8 of the invention, there is provided a manufacturing apparatus of a display unit according to claim 5 or 6, wherein when the ratio of the space formed by the pore space between the sealing agent drawn on one of the substrates and the liquid display material is an area ratio D, it stands that 0.9≦D<1.0,

when the ratio of the height of the liquid material to the height of the sealing agent is defined as F, it stands that 0.1≦E≦0.5, and

in the substrate sticking unit for sticking continuous upper and lower substrates, the inclination angle of one of the substrate to the other substrate is set 5 degrees or above, and the substrates are pressurized at 1 N/cm² or above and stuck together at normal pressures.

### EFFECTS OF THE INVENTION

According to the structures mentioned above, the present invention offers the following effects.

According to claim 1 and claim 5 of the invention, the sealing agent is applied to the substrates, and the liquid display material is applied to the substrates, and the upper and lower substrates are stuck together. Further, the thickness of the upper and lower substrates and the elastic modulus thereof; the linear expansion coefficients of the upper and lower substrates when the substrate having the plural pixels is the upper substrate and the substrate having the driving unit is the lower substrate; and the elastic modulus of the sealing agent are regulated. Accordingly, it is possible to continuously manufacture display units, and prevent warping or peeling of display units after sticking together, and eliminate mixture of air babbles, and prevent the occurrence of uneven images.

According to claim 2 and claim 6 of the invention, it is possible to manufacture liquid crystal display units through an alignment process of applying a photo alignment film, and applying the application sealing agent.

According to claim 3 and claim 7 of the invention, the ratio of the space formed by the pore space between the sealing agent drawn on one of the substrates and the liquid display material is regulated, and the ratio of the height of the liquid material to the height of the sealing agent is regulated, and the continuous upper and lower substrates are stuck together. Further, the inclination angle of one of the substrate to the other substrate is regulated, and the substrates are pressurized at 1 N/cm² or above and stuck together at normal pressures. Accordingly, it is possible to supply the liquid display material sufficiently without its leaking out from the sealing agent, and further to stick the substrates together without mixture of air babbles at normal pressures, and prevent the occurrence of uneven images.

According to claim 4 and claim 8 of the invention, the ratio of the space formed by the pore space between the sealing agent drawn on one of the substrates and the liquid display material is regulated, and the ratio of the height of the liquid material to the height of the sealing agent is regulated, and the substrates are stuck together. Further, the inclination angle of one of the substrate to the other substrate is regulated, and the substrates are pressurized at 1 N/cm² or above and stuck together at normal pressures. Accordingly, it is possible to continuously manufacture display units, and prevent warping or peeling of display units after sticking together, and supply the liquid display material sufficiently without its leaking out from the sealing agent, and further stick the substrates together without mixture of air babbles at normal pressures, and prevent the occurrence of uneven images.

### BEST MODE FOR CARRYING OUT THE INVENTION

Hereinafter, preferred embodiments of a manufacturing method of a display unit and a manufacturing apparatus of a display unit according to the invention are explained, however, these embodiments shows only the most preferable ones, and the invention is not limited to these embodiments.

### [First Invention]

First, an embodiment of a first invention is explained with reference to FIG. 1 through FIG. 4. FIG. 1 shows an entire manufacturing process of a display unit according to the present embodiment, FIG. 2 is a cross sectional view showing a liquid crystal display material made by applying a sealing agent and liquid crystal on a substrate, FIG. 3 is a top view showing the sealing agent and the liquid crystal on the substrate, and FIG. 4 is a partial cross sectional view showing a portion where the liquid crystal is supplied to the sealing agent.

In the manufacturing process of a display unit according to the present embodiment of the invention, upper and lower substrates are made of plastic and in a roll shape, and at least one substrate thereof has plural pixels, and at least the other substrate thereof has a driving circuit, and the upper and lower substrates are stuck together, thereby a display unit is manufactured.

There are various kinds of display units for applications of black and white display and color display, and for drive methods of passive type and active type. Meanwhile, in the present embodiment, a panel that is of the active type and for color display, and structured of a drive circuit substrate made of roll shaped plastic (hereinafter, referred to as “TFT substrate”) and a pixel formation substrate (hereinafter, referred to as “CF substrate”) is explained as an example.

Meanwhile, the present invention is not limited to the kind of panel, and drive methods described in this embodiment, but may be applied also to other kinds of panel, and drive methods.

As shown in FIG. 1, a manufacturing apparatus 1 of a display unit is equipped with a reel-out unit 2 for a TFT substrate, a reel-out unit 3 for a CF substrate, and a wind-up unit 4. A CF substrate 91 that is fed out from the reel-out unit 3 for a CF substrate is stuck to a TFT substrate 90 that is fed out from reel-out unit 2 for a TFT substrate, and the substrates are wound up by the wind-up unit 4.

This manufacturing apparatus 1 of a display unit is equipped with aligning agent application alignment processing units 11, 12, a sealing agent application unit 13, a liquid display material application unit 14, and a substrate sticking unit 15. The TFT substrate 90 and the CF substrate 91 are flexible plastic substrates that can be wound up in a roll shape, and the light aligning agent, the light curing type sealing agent, and the liquid display material are applied and formed on the substrates, on the sides that the respective substrates oppose. As the liquid display material, liquid crystal, or an electrophoretic display material, a polymer dispersed liquid crystal, a polymer network liquid crystal, an electron liquid powder display material, a cholesteric liquid crystal and the like are preferable, meanwhile, liquid crystal is employed in the present embodiment.

In the present embodiment, the aligning agent application alignment processing unit 11 is equipped with a thin film precise application unit 11a, a drying unit 11b and a light radiation unit 11c that can set arbitrary radiation angles. The light aligning agent is applied onto the TFT substrate 90 by the thin film precise application unit 11a, and dried by the drying unit 11b, and light is radiated thereunto at an arbitrary angle by the light radiation unit 11c, thereby a specified alignment process is carried out. In the same manner, the aligning agent application alignment processing unit 12 is equipped with a thin film precise application unit 12a, a drying unit 12b and a light radiation unit 12c that can set arbitrary radiation angles. The light aligning agent is applied onto the CF substrate 91 by the thin film precise application unit 12a, and dried by the drying unit 12b, and light is radiated thereunto at an arbitrary angle by the light radiation unit 12c, thereby a specified alignment process is carried out. In this light alignment process, an alignment film can be formed into a specified pattern continuously, or, intermittently. Further, with regard to the aligning agent, the aligning agent application and the alignment process, those known such as ones described for example in Japanese Patent Application Laid-Open No. 5-323300, Japanese Patent Application Laid-Open No. 6-209633, Japanese Patent Application Laid-Open No. 11-264982 may be employed.

In the sealing agent application unit 13, a sealing agent precise application unit 13a is arranged. The sealing agent precise application unit 13a, as shown in FIG. 2 through FIG. 4, applies the sealing agent 20 in a loop shape at the position corresponding to the aligning film pattern on the TFT substrate 90 on which the aligning film is formed, and forms a sealing frame. Resin is employed as the sealing agent. With regard to the sealing agent and application of the sealing agent, those known such as ones described for example in Japanese Patent Application Laid-Open No. 06-209633, Japanese Patent Application Laid-Open No. 11-264982 may be employed.

In the liquid display material application unit 14, a display material precise application unit 14a is arranged. The display material precise application unit 14a, as shown in FIG. 2 through FIG. 4, supplies previously defoamed liquid crystal 21 into the sealing frame of the sealing agent 20 of loop shape, and the liquid crystal 21 may be formed into arbitrary patterns.

In the substrate sticking unit 15, a positioning mark detection unit 15a, a sticking unit 15b, and a light radiation unit 15c are arranged. The positioning mark detection unit 15a, as shown in FIG. 1 and FIG. 3, detects a positioning mark 90a formed on the TFT substrate 90, and sends the detected position information to a control unit 16. The control unit 16 is structured of a microcomputer, and drives the reel-out unit 2 for a TFT substrate, the reel-out unit 3 for a CF substrate, and the wind-up unit 4 and thereby transfers the TFT substrate 90 and the CF substrate 91. The control unit 16 not only transfers the TFT substrate 90 and the CF substrate 91, but also takes the control over the entire system.

The sticking unit 15b is equipped with a supporting member 15b1 and a pressing member 15b2, and the supporting member 15b1 and pressing member 15b2 are structured of rollers and the like. The sticking unit 15b sets the TFT substrate 90 on which the aligning film, the sealing agent 20, and the liquid crystal 21 are formed, and the CF substrate 91 on which the aligning film is formed, so that the surfaces thereof to be processed should oppose each other as shown in FIG. 4, and holds the liquid crystal 21 by the sealing agent 20 and adheres and fixes the TFT substrate 90 and the CF substrate 91 together. By radiating light by the light radiation unit 15c, the sealing agent 21 is hardened.

The manufacture of the above display unit involves a sealing agent application step of applying a sealing agent onto the substrates, a liquid display material application step of applying a liquid display material onto the substrates, and a substrate sticking step of sticking upper and lower substrates. As shown in FIG. 4, the thickness W1, W2 of the TFT substrate 90 and the CF substrate 91 as the upper and lower substrates is 10 μm to 500 μm and the elastic modulus thereof is 10 MPa to 100 GPa, and when the substrate having the plural pixels is the CF substrate 91 as the upper substrate, and the substrate having the driving unit is the TFT substrate 90 as the lower substrate, and the linear expansion coefficients thereof are defines as A and B respectively, it stands that 1.0≦A/B<1.5, and when the elastic modulus of the sealing agent 20 is defined as C, it stands that 1.0 GPa<C<10.0 GPa.

Herein, the thickness W1, W2 of the TFT substrate 90 and the CF substrate 91 is 10 μm to 500 μm and the elastic modulus thereof is 10 MPa to 100 GPa. If the thickness W1, W2 of the TFT substrate 90 and the CF substrate 91 is lower than the specified range, their strength becomes insufficient; and if the thickness is over the specified range, the panel size must increase. Therefore, by setting them in the specified range, it is possible to manufacture strong and compact panels. Further, if the elastic modulus of the TFT substrate 90 and the CF substrate 91 is lower than the specified range, the substrates are apt to be deformed; and if the elastic modulus is over the specified range, the substrates are apt to be hardly deformed. Therefore, by setting them in the specified range, it is possible to smoothly transfer the TFT substrate 90 and the CF substrate 91, and to prevent warping or peeling or uneven images of display panels after sticking together.

When the linear expansion coefficients of the CF substrate 91 and the TFT substrate 90 are defines as A and B respectively, it stands that 1.0≦A/B<1.5, and when the elastic modulus C of the sealing agent 20 is defined as C, it stands that 1.0 GPa<C<10.0 GPa. If the ratio A/B of the linear expansion coefficients of the CF substrate 91 and the TFT substrate 90 is within the specified range, and the elastic modulus C of the sealing agent 20 is within the specified range, even if the substrate tends to warp when they are made into a panel since the expansion amount of one of the substrate becomes large due to the difference in the linear expansion coefficients of the CF substrate 91 and the TFT substrate 90 as the upper and lower substrates, it is possible to absorb the deformation in the elasticity range of the sealing agent 20. However, if the ratio A/B of the linear expansion coefficients of the CF substrate 91 and the TFT substrate 90 is out the specified range, or the elastic modulus C of the sealing agent 20 is out of the specified range, the deformation cannot be absorbed by the sealing agent, and the panel sees warping and the like, and further in some cases, a phenomenon where the sealing agent peel off occurs. Further, by the deformation, not merely problems in their external appearance occur, but also performances as a display unit, for example uniform display performance in the panel and the like are deteriorated.

### EXAMPLES

By use of the manufacturing apparatus of the display unit mentioned above, display units of normally white structure 4-inch liquid crystal panels with an aspect ratio 4:3 were manufactured and evaluated in combinations shown in Table 1 by use of plastic substrates of different thickness, linear expansion coefficients, and sealing agents of different elastic moduli.

The evaluation items were display unevenness and panel warping and peeling of sealing agents, and with regard to the evaluation method, after panels were manufactured, a specified voltage was given by an action tester and a certain image was displayed. The evenness in the screens when the display units were turned on, that is, display unevenness due to dark and light differences of black was checked by visual inspection.

Further, with regard to the panel external appearances just after the upper and lower substrates were stuck together, warping and sealing agent peeling were measured and checked by a height gauge (manufactured by Mitsutoyo) and by visual inspection.

In the Example 1), as the substrate, Polyether Sulfone (FS-1300) manufactured by Sumitomo Bakelite Co., Ltd. of thickness 100 μm, elastic modulus 2.0 GPa, and linear expansion coefficient 56 ppm/° C. was employed, and as the sealing agent, UV curing type sealing agent (3025G) manufactured by ThreeBond of elastic modulus 2.0 GPa was employed, and as the liquid crystal, RDP-93046 manufactured by Dainippon Ink and Chemicals, Incorporated was employed.

In the Example 2) and after that, panels were manufactured by use of various different materials.

The results are shown in Table 1.

The mark “G” denotes a preferable evaluation result, meanwhile, the mark “F” denotes an inferior evaluation result.

With regard to the warping, the measurement was made on a level block by use of the height gauge, and warping over 5 mm was evaluated as “F”.

As the result, it has been found that when the thickness of the upper and lower substrates is 10 μm to 500 μm and the elastic modulus thereof is 10 MPa to 100 GPa, and the ratio A/B of the linear expansion coefficients of the upper and lower substrates is in the range 1.0≦A/B<1.5, and the elastic modulus C of the sealing agent is in the range 1.0 GPa<C<GPa, the display unevenness and panel warping and peeling of sealing agents can be prevented, and the manufactured plastic substrates have no problem in the performances as display units.

TABLE 1

| | | | | | | A | B | | | | | |
|---|---|---|---|---|---|---|---|---|---|---|---|---|
| | | | | | | Substrate linear | | | | | | |
| | | | | | | expansion | | | C | | | |
| | | Substrate | | Substrate elastic | | coefficient | | | Sealing | | | |
| | | thickness (μm) | | modulus (GPa) | | (ppm/° C.) | | | agent elastic | Results | | |
| | | Upper | Lower | Upper | Lower | Upper | Lower | A/B | modulus (GPa) | Unevenness | Warping | Peeling |
| Example | \textcircled{1} | 100 | 100 | 2 | 2 | 56 | 56 | 1.00 | 2 | ◯ | ◯ | ◯ |
| | \textcircled{2} | 100 | 100 | 0.05 | 0.1 | 90 | 85 | 1.06 | 1.1 | ◯ | ◯ | ◯ |
| | \textcircled{3} | 100 | 100 | 0.1 | 1 | 85 | 80 | 1.06 | 1.1 | ◯ | ◯ | ◯ |
| | \textcircled{4} | 100 | 100 | 1 | 5 | 80 | 70 | 1.14 | 5 | ◯ | ◯ | ◯ |
| | \textcircled{5} | 100 | 100 | 5 | 10 | 70 | 55 | 1.27 | 5 | ◯ | ◯ | ◯ |
| | \textcircled{6} | 100 | 100 | 10 | 10 | 55 | 55 | 1.00 | 5 | ◯ | ◯ | ◯ |
| | \textcircled{7} | 100 | 100 | 10 | 50 | 55 | 45 | 1.22 | 5 | ◯ | ◯ | ◯ |
| | \textcircled{8} | 100 | 100 | 50 | 50 | 45 | 45 | 1.00 | 9.9 | ◯ | ◯ | ◯ |
| | \textcircled{9} | 100 | 100 | 50 | 100 | 45 | 35 | 1.29 | 9.9 | ◯ | ◯ | ◯ |
| | \textcircled{10} | 100 | 100 | 100 | 100 | 30 | 30 | 1.00 | 9.9 | ◯ | ◯ | ◯ |
| | \textcircled{11} | 12.5 | 500 | 10 | 10 | 55 | 55 | 1.00 | 2 | ◯ | ◯ | ◯ |
| | \textcircled{12} | 500 | 12.5 | 10 | 10 | 55 | 55 | 1.00 | 5 | ◯ | ◯ | ◯ |
| | \textcircled{13} | 100 | 100 | 0.01 | 100 | 100 | 90 | 1.11 | 5 | ◯ | ◯ | ◯ |
| | \textcircled{14} | 100 | 100 | 100 | 0.01 | 100 | 100 | 1.00 | 5 | ◯ | ◯ | ◯ |
| | \textcircled{15} | 12.5 | 12.5 | 100 | 100 | 100 | 100 | 1.00 | 5 | ◯ | ◯ | ◯ |
| | \textcircled{16} | 500 | 500 | 0.01 | 0.01 | 100 | 70 | 1.43 | 5 | ◯ | ◯ | ◯ |
| Compar- | \textcircled{1} | 100 | 100 | 0.01 | 10 | 100 | 55 | 1.82 | 2 | X | X | ◯ |
| ative | \textcircled{2} | 100 | 100 | 0.05 | 10 | 90 | 55 | 1.64 | 2 | X | ◯ | ◯ |
| Example | \textcircled{3} | 100 | 100 | 1 | 50 | 80 | 45 | 1.78 | 9.9 | X | X | ◯ |
| | \textcircled{4} | 100 | 100 | 10 | 100 | 55 | 30 | 1.83 | 10 | X | X | X |
| | \textcircled{5} | 100 | 100 | 10 | 5 | 55 | 70 | 0.79 | 5 | X | X | ◯ |
| | \textcircled{6} | 100 | 100 | 50 | 10 | 45 | 55 | 0.82 | 9.9 | X | X | ◯ |
| | \textcircled{7} | 100 | 100 | 10 | 10 | 55 | 55 | 1.00 | 1 | X | X | ◯ |
| | \textcircled{8} | 100 | 100 | 10 | 50 | 55 | 45 | 1.22 | 1 | X | ◯ | ◯ |
| | \textcircled{9} | 100 | 100 | 50 | 50 | 45 | 45 | 1.00 | 10 | X | X | ◯ |
| | \textcircled{10} | 100 | 100 | 50 | 100 | 45 | 30 | 1.50 | 10 | X | X | X |
| | \textcircled{11} | 10 | 550 | 10 | 10 | 110 | 80 | 1.38 | 2 | X | ◯ | ◯ |
| | \textcircled{12} | 5 | 500 | 10 | 10 | 120 | 90 | 1.33 | 2 | X | ◯ | ◯ |
| | \textcircled{13} | 10 | 500 | 0.01 | 120 | 110 | 75 | 1.47 | 2 | X | ◯ | ◯ |
| | \textcircled{14} | 10 | 500 | 0.005 | 100 | 120 | 85 | 1.41 | 2 | X | ◯ | ◯ |

### [Second Invention]

Next, a preferred embodiment of a second invention is explained with reference to FIG. 5 through FIG. 8. FIG. 5 is a cross sectional view showing a liquid crystal display material made by applying a sealing agent and liquid crystal on a substrate, FIG. 6 is a top view showing the sealing agent and the liquid crystal applied on the substrate, and FIG. 7 is a cross sectional view showing the portions to be stuck together, and FIG. 8 shows the inclination angle of one of the substrate to the other substrate.

In this embodiment, in the manufacturing method and the manufacturing apparatus mentioned above, when the CF substrate 91 and the TFT substrate 90 as the upper and lower substrates are stuck together via the sealing agent 20 and the liquid crystal 21 as shown in FIG. 5 through FIG. 7, to the sealing agent 20 that is formed into a loop shape on the TFT substrate 90 as the lower substrate, an appropriate amount of the liquid crystal 21 is formed with a space (air gap) 22 to the sealing agent 20, and when the ratio of the formation area of the liquid crystal 21 to the sealing frame inside area is defined as D, and further the ratio of the sealing agent height H1 to the liquid crystal height H2 is defined as E, it stands that 0.9≦D<1.0, 0.1≦E≦0.5, and in sticking the continuous upper and lower substrates, the inclination angle of one of the substrate to the other substrate is set 5 degrees or above, and the substrates are pressurized at 1 N/cm² or above and stuck together at normal pressures.

The inclination angle of one of the substrate to the other substrate, as shown in FIG. 8, is the sticking initial angle that is a certain angle made by the CF substrate 91 as the upper substrate being pressed by the pressing member 15b2, to the TFT substrate 90 as the lower substrate. In other words, the sticking initial angle that is made by the straight line that the upper substrate connects the contact point of the roller 8 and the pressing member 15b2 and the lower substrate is made the inclination angle.

When the ratio of the formation area of the liquid crystal 21 to the sealing frame inside area is defined as D, and further the ratio of the sealing agent height H1 to the liquid crystal height H2 is defined as E, it stands that 0.9≦D<1.0, and 0.1≦E≦0.5 respectively, and the sticking inclination angle of the upper substrate to the lower substrate and the pressing force at the moment of sticking together are set within the specified ranges respectively, it is possible to press a panel to the set gap, and by sticking the substrates together from the sealing frame end surfaces, it is possible to obtain a panel into which the liquid crystal is encapsulated, without air babbles, and free of the liquid crystal 21 leaking out from the sealing frame and free of air gap.

In the out of the specified ranges, by deflection of the plastic substrates and the like, when the upper and lower substrates are stuck together from their ends, there are phenomena that their midstream sticks together, and the pressing states of the sealing agent 20 and the liquid crystal 21 are uneven and the like, and consequently air bubbles are left therein and on the other side, the sealing agent 20 leaks out, or it is not pressed to the specified gap height and so forth. Further, due to the phenomena, not merely problems in their external appearance occur, but also performances as a display unit, for example uniform display performance in the panel and the like are deteriorated.

By use of the manufacturing apparatus of the display unit mentioned above, display units of normally white structure 4-inch liquid crystal panels with an aspect ratio 4:3 were manufactured and evaluated in combinations shown in Table 2 by use of materials that satisfy the first invention.

The evaluation items were display unevenness and panel warping and peeling of sealing agents, and with regard to the evaluation method, after panels were manufactured, a specified voltage was given by an action tester and a certain image was displayed. The evenness in the screens when the display units were turned on, that is, display unevenness due to dark and light differences of black was checked by visual inspection.

Further, with regard to the panel external appearances just after the upper and lower substrates were stuck together, the presence or the absence of air bubbles, and leak-out of liquid crystal from the sealing agent were measured and checked by a microscope (manufactured by Keyence Corporation) and by visual inspection.

In all the Examples, as the substrate, Polyether Sulfone (FS-1300) manufactured by Sumitomo Bakelite Co., Ltd. of thickness 100 μm, elastic modulus 2.0 GPa, and linear expansion coefficient 56 ppm/° C. was employed, and as the sealing agent, UV curing type sealing agent (3025G) manufactured by ThreeBond of elastic modulus 2.0 GPa was employed, and as the liquid crystal, RDP-93046 manufactured by Dainippon Ink and Chemicals, Incorporated was employed.

In the Example 1), the sealing agent and the liquid crystal were formed in the relations of the area ratio 0.9 and the height ratio 0.3, and the sticking initial angle is set to 5 degrees, and by use of rollers, the substrates are pressurized at 1 N/cm² or above and stuck together at normal pressures.

In the Example 2) and after that, panels were manufactured in the same manners with different conditions.

The results are shown in Table 2.

The mark “G” denotes a preferable evaluation result, meanwhile, the mark “F” denotes an inferior evaluation result.

Meanwhile, with regard to the air bubbles, ones whose diameter was over 20 μm were evaluated as “F”.

TABLE 2

| | | D | E | | | | | |
|---|---|---|---|---|---|---|---|---|
| | | Area | Height ratio of sealing | Angle | Pressing | Results | | |
| | | ratio | agent and liquid crystal | (degrees) | force (N/cm²) | Unevenness | Air bubbles | Air bubbles |
| Example | \textcircled{1} | 0.9 | 0.3 | 5 | 1 | ◯ | ◯ | ◯ |
| | \textcircled{2} | 0.9 | 0.3 | 5 | 2 | ◯ | ◯ | ◯ |
| | \textcircled{3} | 0.9 | 0.3 | 20 | 1 | ◯ | ◯ | ◯ |
| | \textcircled{4} | 0.9 | 0.3 | 30 | 1 | ◯ | ◯ | ◯ |
| | \textcircled{5} | 0.9 | 0.1 | 5 | 2 | ◯ | ◯ | ◯ |
| | \textcircled{6} | 0.9 | 0.1 | 5 | 1 | ◯ | ◯ | ◯ |
| | \textcircled{7} | 0.9 | 0.5 | 20 | 1 | ◯ | ◯ | ◯ |
| | \textcircled{8} | 0.9 | 0.5 | 5 | 1 | ◯ | ◯ | ◯ |
| | \textcircled{9} | 0.95 | 0.1 | 5 | 1 | ◯ | ◯ | ◯ |
| | \textcircled{10} | 0.95 | 0.5 | 5 | 1 | ◯ | ◯ | ◯ |
| | \textcircled{11} | 0.99 | 0.3 | 5 | 1 | ◯ | ◯ | ◯ |
| | \textcircled{12} | 0.99 | 0.3 | 5 | 2 | ◯ | ◯ | ◯ |
| | \textcircled{13} | 0.99 | 0.3 | 5 | 3 | ◯ | ◯ | ◯ |
| | \textcircled{14} | 0.99 | 0.3 | 20 | 1 | ◯ | ◯ | ◯ |
| | \textcircled{15} | 0.99 | 0.1 | 5 | 1 | ◯ | ◯ | ◯ |
| | \textcircled{16} | 0.99 | 0.5 | 30 | 1 | ◯ | ◯ | ◯ |
| Comparative | \textcircled{1} | 0.85 | 0.3 | 5 | 1 | X | X | ◯ |
| Example | \textcircled{2} | 0.85 | 0.3 | 30 | 3 | X | X | ◯ |
| | \textcircled{3} | 0.85 | 0.05 | 5 | 1 | X | X | ◯ |
| | \textcircled{4} | 0.9 | 0.05 | 5 | 1 | X | ◯ | ◯ |
| | \textcircled{5} | 0.9 | 0.3 | 4 | 1 | X | X | ◯ |
| | \textcircled{6} | 0.9 | 0.3 | 2 | 1 | X | X | ◯ |
| | \textcircled{7} | 0.9 | 0.3 | 5 | 0.9 | X | ◯ | ◯ |
| | \textcircled{8} | 0.95 | 0.3 | 5 | 0.5 | X | ◯ | ◯ |
| | \textcircled{9} | 0.95 | 0.3 | 4 | 0.9 | X | X | ◯ |
| | \textcircled{10} | 0.95 | 0.55 | 30 | 1 | X | ◯ | ◯ |
| | \textcircled{11} | 1 | 0.55 | 5 | 1 | X | ◯ | X |
| | \textcircled{12} | 1 | 0.55 | 4 | 0.9 | X | X | X |
| | \textcircled{13} | 1 | 0.3 | 4 | 1 | X | X | X |
| | \textcircled{14} | 1 | 0.3 | 20 | 0.9 | X | ◯ | X |

the liquid crystal formation area to the sealing frame inside area is defined as D, it stands that 0.9≦D<1.0, and further, the ratio of the sealing agent height to the liquid crystal height is defined as E, it stands that 0.1≦E≦0.5, and furthermore, the sticking inclination of the upper substrate to the lower substrate is set 5 degrees, and the pressing force thereof is 1 N/cm² or above, and the manufactured plastic substrates have no problem in the performances as display units.

Meanwhile, the second invention has been explained with the embodiments and examples in which, in the manufacturing method and the manufacturing apparatus mentioned above, when the ratio of the liquid crystal formation area to the sealing frame inside area is defined as D, it stands that 0.9≦D<1.0, and further, the ratio of the sealing agent height to the liquid crystal height is defined as E, it stands that 0.1≦E≦0.5, and furthermore, the sticking inclination of the upper substrate to the lower substrate is set 5 degrees, and the pressing force thereof is 1 N/cm² or above. However, the present invention is not limited to them, but may be applied to a manufacturing method of a display unit and a manufacturing apparatus of a display unit in which upper and lower substrates are made of plastic and in a roll shape, and at least one substrate thereof has plural pixels, and at least the other substrate thereof has a driving circuit, and the upper and lower substrates are stuck together.

### INDUSTRIAL APPLICABILITY

The present invention may be a manufacturing method of a display unit and a manufacturing apparatus of a display unit for manufacturing a display unit in which upper and lower substrates are made of plastic and in a roll shape, and at least one substrate thereof has plural pixels, and at least the other substrate thereof has a driving circuit, and the upper and lower substrates are stuck together, and thereby it is possible to continuously manufacture display units, and prevent warping or peeling of display units after sticking together, and eliminate mixture of air babbles, and prevent the occurrence of uneven images.

### BRIEF DESCRIPTION OF THE DRAWINGS

FIG. 1 shows an entire manufacturing process of a display unit according to the present embodiment.

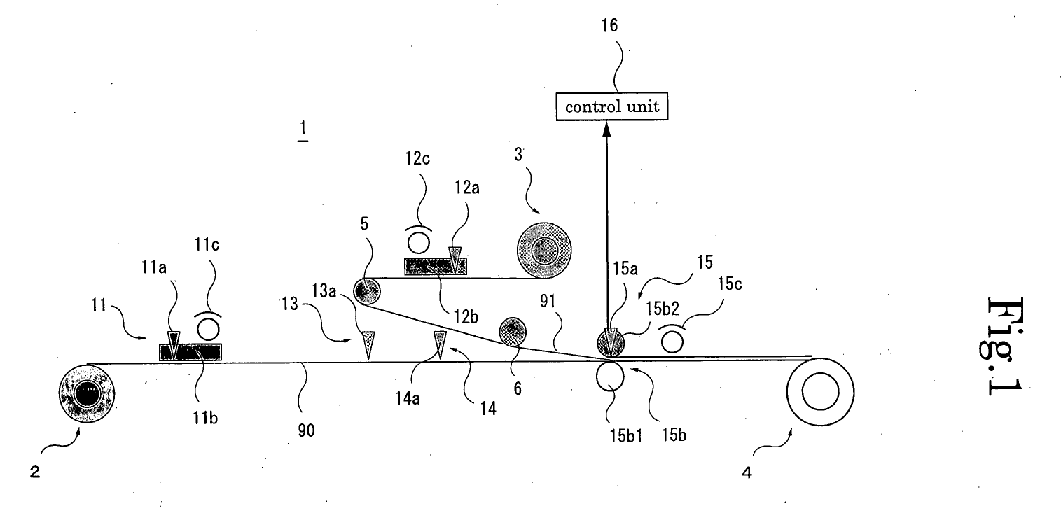

FIG. 2 is a cross sectional view showing a liquid crystal display material made by applying a sealing agent and liquid crystal on a substrate.

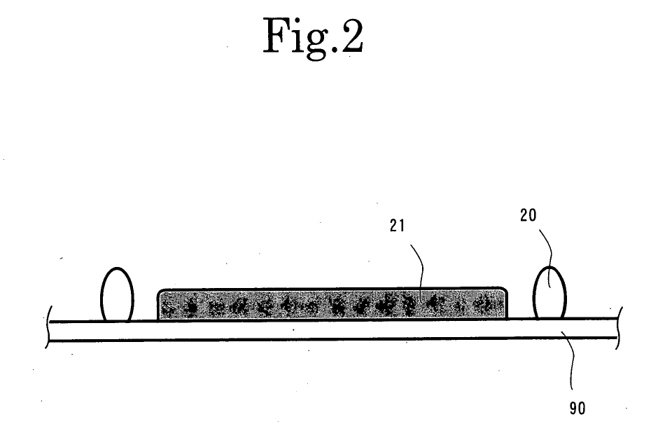

FIG. 3 is a top view showing the sealing agent and the liquid crystal on the substrate.

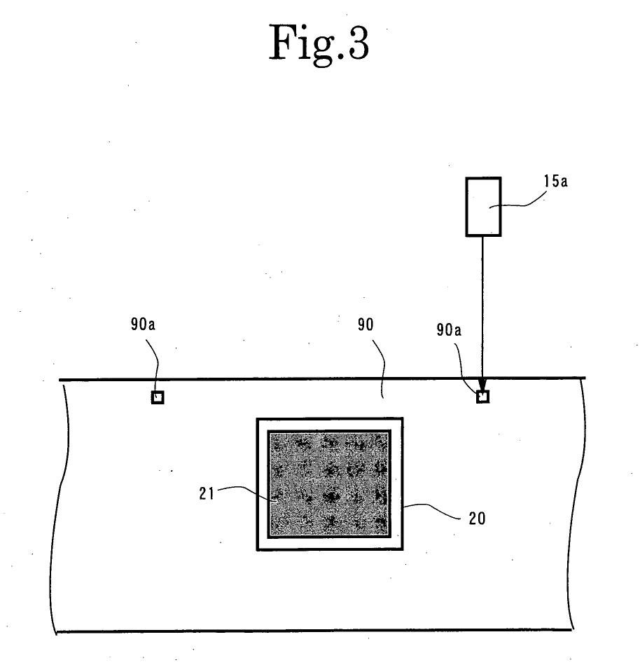

FIG. 4 is a partial cross sectional view showing a portion where the liquid crystal is supplied to the sealing agent.

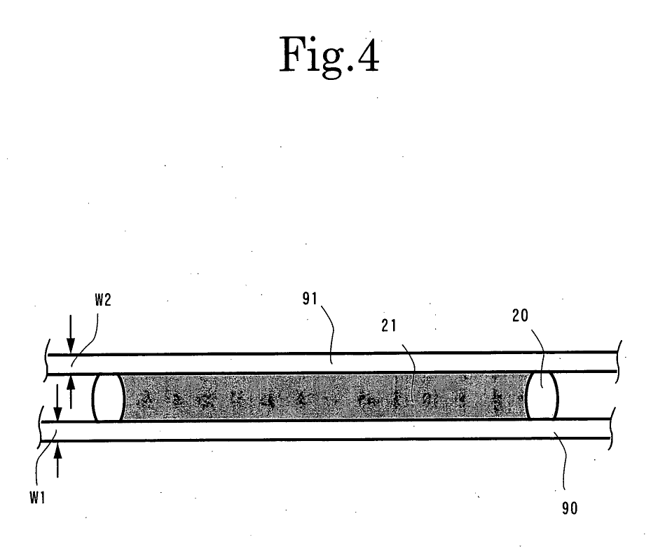

FIG. 5 is a cross sectional view showing a liquid crystal display material made by applying a sealing agent and liquid crystal on a substrate.

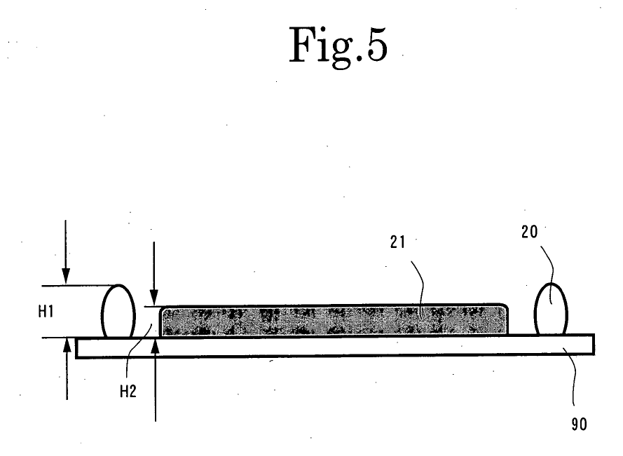

FIG. 6 is a top view showing the sealing agent and the liquid crystal applied on the substrate.

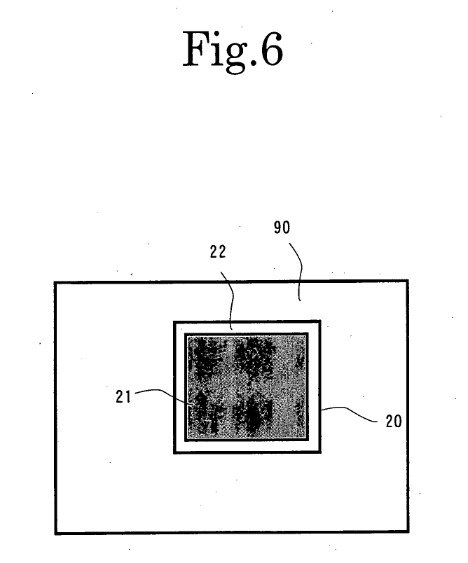

FIG. 7 is a cross sectional view showing the portions to be stuck together.

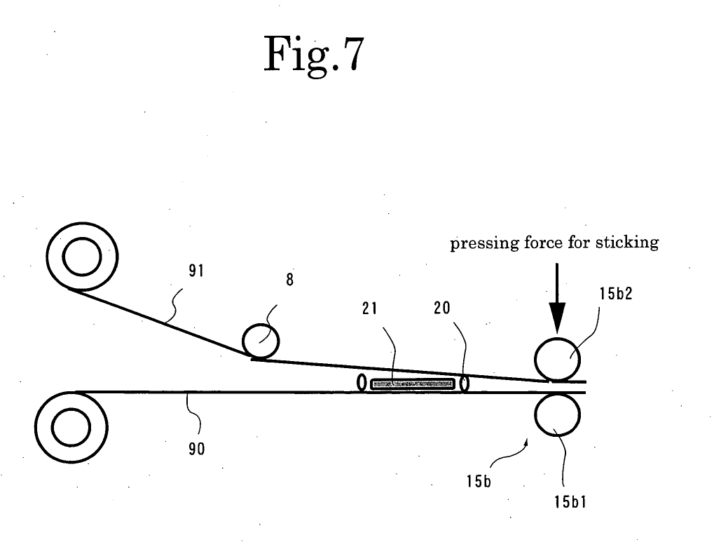

FIG. 8 shows the inclination angle of one of the substrate to the other substrate.

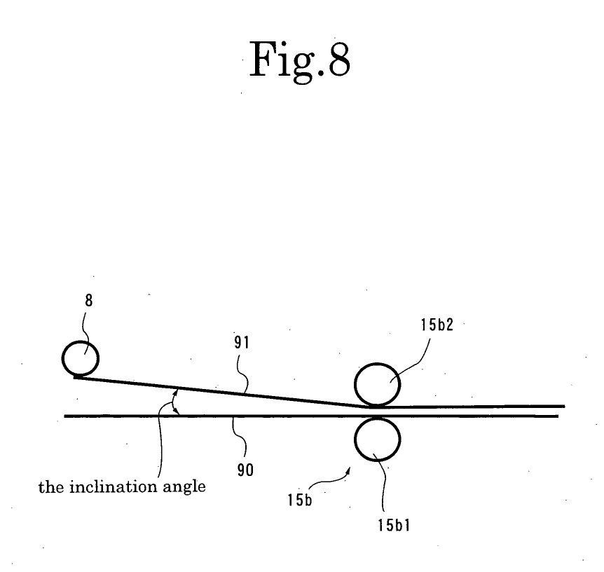

### DESCRIPTION OF REFERENCE NUMERALS

1 Manufacturing apparatus of a display unit
2 Reel-out unit for a TFT substrate
3 Reel-out unit for a CF substrate
4 Wind-up unit
11,12 Aligning agent application alignment processing unit
13 Sealing agent application unit
14 Liquid display material application unit
15 Substrate sticking unit
90 TFT substrate
91 CF substrate

1. A manufacturing method of a display unit in which upper and lower substrates are made of plastic and in a roll shape, and at least one substrate thereof has plural pixels, and at least the other substrate thereof has a driving circuit, and the upper and lower substrates are stuck together, the manufacturing method comprising at least
a sealing agent application step of applying a sealing agent onto the substrates,
a liquid display material application step of applying a liquid display material onto the substrates, and
a substrate sticking step of sticking upper and lower substrates, wherein
the thickness of the upper and lower substrates is 10 μm to 500 μm and the elastic modulus thereof is 10 MPa to 100 GPa, and
when the substrate having the plural pixels is the upper substrate, and the substrate having the driving unit is the lower substrate, and the linear expansion coefficients thereof are defines as A and B respectively, it stands that 1.0≦A/B<1.5, and when the elastic modulus of the sealing agent is defined as C, it stands that 1.0 GPa<C<10.0 GPa.

2. A manufacturing method of a display unit according to claim 1, further comprising a photo alignment film application step of performing an alignment process of applying a photo alignment film, before the sealing agent application step.

3. A manufacturing method of a display unit in which upper and lower substrates are made of plastic and in a roll shape, and at least one substrate thereof has plural pixels, and at least the other substrate thereof has a driving circuit, and the upper and lower substrates are stuck together, wherein
when the ratio of the space formed by the pore space between the sealing agent drawn on one of the substrates and the liquid display material is an area ratio D, it stands that 0.9≦D<1.0,
when the ratio of the height of the liquid material to the height of the sealing agent is defined as F, it stands that 0.1≦E≦0.5, and
in the substrate sticking step of sticking continuous upper and lower substrates, the inclination angle of one of the substrate to the other substrate is set 5 degrees or above, and the substrates are pressurized at 1 N/cm² or above and stuck together at normal pressures.

4. A manufacturing method of a display unit according to claim 1, wherein
when the ratio of the space formed by the pore space between the sealing agent drawn on one of the substrates and the liquid display material is an area ratio D, it stands that 0.9≦D<1.0,
when the ratio of the height of the liquid material to the height of the sealing agent is defined as F, it stands that 0.1≦E≦0.5, and
in the substrate sticking step of sticking continuous upper and lower substrates, the inclination angle of one of the substrate to the other substrate is set 5 degrees or above, and the substrates are pressurized at 1 N/cm² or above and stuck together at normal pressures.

5. A manufacturing apparatus of a display unit in which upper and lower substrates are made of plastic and in a roll shape, and at least one substrate thereof has plural pixels, and at least the other substrate thereof has a driving circuit, and the upper and lower substrates are stuck together, the manufacturing apparatus comprising at least
a sealing agent application unit for applying a sealing agent onto the substrates,
a liquid display material application unit for applying a liquid display material onto the substrates, and
a substrate sticking unit for sticking upper and lower substrates, wherein
the thickness of the upper and lower substrates is 10 μm to 500μ and the elastic modulus thereof is 10 MPa to 100 GPa, and
when the substrate having the plural pixels is the upper substrate, and the substrate having the driving unit is the lower substrate, and the linear expansion coefficients thereof are defines as A and B respectively, it stands that 1.0≦A/B<1.5, and
when the elastic modulus of the sealing agent is defined as C, it stands that 1.0 GPa<C<10.0 GPa.

6. A manufacturing apparatus of a display unit according to claim 5, further comprising a photo alignment film application unit for performing an alignment process of applying a photo alignment film, before the sealing agent application unit.

7. A manufacturing apparatus of a display unit in which upper and lower substrates are made of plastic and in a roll shape, and at least one substrate thereof has plural pixels, and at least the other substrate thereof has a driving circuit, and the upper and lower substrates are stuck together, wherein
when the ratio of the space formed by the pore space between the sealing agent drawn on one of the substrates and the liquid display material is an area ratio D, it stands that 0.9≦D<1.0,
when the ratio of the height of the liquid material to the height of the sealing agent is defined as F, it stands that 0.1≦E≦0.5, and
in the substrate sticking unit for sticking continuous upper and lower substrates, the inclination angle of one of the substrate to the other substrate is set 5 degrees or above, and the substrates are pressurized at 1 N/cm² or above and stuck together at normal pressures.

8. A manufacturing apparatus of a display unit according to claim 5, wherein
when the ratio of the space formed by the pore space between the sealing agent drawn on one of the substrates and the liquid display material is an area ratio D, it stands that 0.9≦D<1.0,
when the ratio of the height of the liquid material to the height of the sealing agent is defined as F, it stands that 0.1≦E≦0.5, and
in the substrate sticking unit for sticking continuous upper and lower substrates, the inclination angle of one of the substrate to the other substrate is set 5 degrees or above, and the substrates are pressurized at 1 N/cm² or above and stuck together at normal pressures.
